(19) United States
(12) Patent Application Publication
(10) Pub. No.: US 2009/0041059 A1
(43) Pub. Date: Feb. 12, 2009

(54) TRANSMISSION AND RECEPTION SYSTEM AND METHOD BASED ON CODE DIVISION

(75) Inventor: Arnaldo Spalvieri, Milano (IT)

Correspondence Address: OBLON, SPIVAK, MCCLELLAND MAIER & NEUSTADT, P.C., 1940 DUKE STREET, ALEXANDRIA, VA, 22314, US

(73) Assignee: POLITECNICO DI MILANO, Milano (IT)

(21) Appl. No.: 11/995,252

(22) PCT Filed: Feb. 23, 2006
(86) PCT No.: PCT/IT2006/000097

§ 371 Date: Aug. 4, 2008

(30) Foreign Application Priority Data
Feb. 23, 2005 (IT) BG2005A000009

(51) Int. Cl. H04J 13/00

(52) U.S. Cl. 370/479

(57) ABSTRACT

The code division (CDMA) transmission method includes the step of multiplying a signal (a) to be transmitted, represented by a vector, by a matrix (S), whose result is represented by a vector (x), said method being characterized in that: • taking a basic sequence with substantially-ideal periodic autocorrelation; • constructing said matrix (S) by a cyclical translation of said basic sequence, in such a way that the columns of said matrix (S) are the cyclical shifts of the basic sequence; • adding a cyclic prefix to said resulting vector (x).

The present invention relates to a transmission and reception system used in communication systems based on code division CDMA (Code Division Multiple Access), and also to a method for transmission and reception based on code division.

Specifically, the present invention relates to systems based on synchronous CDMA, as, for instance, systems used in radio communications from the base station to the users in mobile cellular radio systems.

In the recent years, cellular transmission systems using CDMA technology have experienced a large success.

In transmission based on CDMA, each user has access to the entire spectrum and he is identified by a code. Therefore many users can transmit messages using the same frequency and different codes at the same time.

However, when many users are reached at the same time by the communication service, the many signals can mutually interfere, generating the so-called MUI (Multi User Interference). As a consequence, the maximum number of users that can be reached at the same time by the communication service should be kept small to maintain the interference at a tolerable level.

### BACKGROUND ART

To mitigate this drawback, one can resort to reception techniques based on interference cancellation. However, the complexity of circuits and algorithms of said reception technique is very high.

### OBJECT OF THE INVENTION

The main object of the present invention is to setting up a system based on code division robust against MUI, with reduced complexity of the receiver front-end circuits.

### SUMMARY OF THE INVENTION

The purpose of the invention is thus to provide a method of transmission and reception based on code division (CDMA), and by a system of transmission and reception based on code division (CDMA), as disclosed in the attached claims.

### BRIEF DESCRIPTION OF THE DRAWINGS

The invention will now be described, by way of example only, with reference to the enclosed figure of drawings, wherein;

FIG. 1 shows a block diagram of the transmitted according to the present invention;

FIG. 2 shows a block diagram of the receiver according to the present invention.

Supposing to have N independent users, the i-th of which wants to transmit through the channel the modulated symbol aᵢ. Following said assumpion, the multiplexed column vector is constructed:

x=(x₁,x₂. . . ,x_{N})^{T,}

where the superscript ^{T} indicates the transposed vector, as

x=S·a (1)

where S is a square matrix N×N whose columns are the code sequences, x is the multiplexed signal to be transmitted over the common channel to the N users. In the UMTS standard, the columns of S are the Hadamard sequences in the link from the base station and the users (downlink).

Hadamard sequences are orthogonal, therefore

S^{H}S=I (2)

where I is the identity matrix and the superscript H denotes the transpose conjugate. Moreover, the elements of Hadamard sequences have constant amplitude, therefore

|s_{i,j}|²=1/N

It is well known that, when the multiplexed signal is received from a multi-path channel, the performance of the system may suffer, because the distortion induced by the channel destroys the orthogonality between the code sequences. As a result, the symbol of each user causes interference on the symbol of each other user. This impairment, called MultiUser Interference (MUI), can be mitigated (not eliminated) by a proper design of the receiver. However, the complexity of the optimal receiver goes with |A|^{H} (Verdù, 86), therefore, in many practical cases, a suboptimal receivers is usually implemented, accepting the performance loss.

The code of sequences, according to the teachings of the paper by K. W. Yip e T. S. Ng, “Code phase assignment—A technique for high capacity indoor mobile DS-CDMA communications”, Proceedings of VTC, pp. 1586-1590, 1994, is constructed by the cyclical translation of a basic sequence s=(s₀,s₁, . . . , s_{N-1}).

When this construction is adopted, matrix S takes the form of a periodic convolution matrix;

$$S = [ \begin{matrix}{s}_{0} & {s}_{N - 1} & … & {s}_{1} \\ {s}_{1} & {s}_{0} & … & {s}_{2} \\ … & … & … & … \\ {s}_{N - 1} & {s}_{N - 2} & … & {1}^{s} θ\end{matrix} ] \qquad ( 3 )$$

Given a basic sequence (s₀, s₁, . . . , s_{N-1}), N being the length of the sequence, one constructs from this sequence its N−1 cyclical translations. Specifically, the first of the N−1 cyclical translations is obtained by translation of one position of all the elements of the sequence, while the last element becomes the first; the successive cyclical translations are obtained in the same way, starting from the previous cyclical translation.

As it appears from (3) the said cyclical translations are the columns of matrix S.

The multiplexed signal x can be seen as the periodic convolution between the data sequence a and matrix S obtained from the basic sequence. In the above mentioned paper by Yip and Ng it is suggested to use a m-sequence as a basic sequence.

It should be observed that the code sequences by Yip e Ng, that are obtained from the cyclical translations of a m-sequence, do not form an orthonormal basis.

This can be seen by putting

R=S^{H}S.

The element i, j of R is

r_{i,j}=1/N, i≢j

r_{i,j}=1, i=j

where

|sᵢ|²=1/N

Let us now consider a matrix S constructed from the cyclical translation of any basic sequence, hence not necessarily an m-sequence.

According to the present invention, we claim the adding of a cyclical prefix to the multiplexed signal before transmission, as it is common in OFDM systems after Abraham Peled e Antonio Ruiz, “Frequency domain data transmission using reduced computational complexity algorithms”, pp. 964-966, IEEE 1980. Let M be the length of the cyclic prefix. M elements are taken from the tail of x and they are added to the head of the same vector.

After adding the cyclic prefix, the transmitted sequence associated to the multiplexed signal x is

x_{N-M+1}, . . . , x_{N}, x₁, x₂, . . . , x_{N}.

It is known that, adding the cyclic prefix and removing it after the channel, one forces the channel to perform cyclic convolution, having supposed that the length of the impulse response of the time-discrete channel in not longer than M, for instance in wireless systems one has N=64 e M=16.

Having removed the cyclic prefix, the output of the channel is

y=Gx+w, (5)

where w is the vector of samples of AWGN (Additive White Gaussian Noise), with discrete power spectrum N₀, and G is the periodic convolution matrix constructed from the impulse response of the time-discrete channel. Specifically, the columns of G are obtained from the cyclical translations of the impulse response of the channel.

Demultiplexing is obtained as the periodic correlation between s and y

v=S^{H}y (6)

Substituting (5) in (6) one finds

v=S^{H}G S a+S^{H}w, (7)

where the autocorrelation matrix of the noise term S^{H} w is N₀ S^{H} S.

Note that, due to the specific construction of matrix S (cyclical translation of a basic sequence), all the matrices appearing in (7) are periodic convolution matrices, henceforth the first term in the right side of (7) can be seen as the result of a periodic convolution.

Specifically,

R=S^{H} S

where R is a periodic correlation matrix and, as such, it is also a periodic convolution matrix. Using the commutative property of convolution we get

v=G R a+S^{H}w, (8)

In conclusion, adding a cyclic prefix to the multiplexed sequence according to (1) and (3), we induce a convolutional model for signal demultiplexing.

The shortcoming of the code by Yip and Ng is that, as noted before, the cyclical translations of a m-sequence do not form an orthonormal basis. Specifically, since all the elements of any column of R are not zero, the memory of the convolutional model expressed in (8) is N. It is known that the optimal receiver for the convolutional model is the Viterbi algorithm. Observe that the complexity of Viterbi algorithm for a convolutional model with memory v goes as |A|^{v}, therefore the complexity of the optimal receiver for the code by Yip and NG goes as |A|^{N}, exactly as it happens with Hadamard sequences.

Consider now the construction of matrix S, with s a sequence with ideal periodic autocorrelation, for instance, for N=4, one such sequence is (0.5, 0.5, 0.5, −0,5).

This means that the columns of matrix S are orthogonal

S^{H}S=I

Moreover, the matrix of code sequences has also the property of being a periodic convolution matrix, making appropriate the convolutional model given in (8). Using the orthogonality of code sequences in (8) we get

v=G a+S^{H}w, (9)

where, from (2), the noise term S^{H}w is statistically equivalent to w.

Observe that (9) is the classical time-discrete AWGN model for the InterSymbol Interference (ISI) which is commonly adopted in conventional time division multiplexing systems. Also note that, when the basic sequence has ideal autocorrelation, a cyclic prefix is added, and matrix S is obtained from the cyclical translations of a basic sequence, it happens that the memory of the convolutional model given in (9) is the memory of the channel. Summarizing, this nice property is obtained by using the construction by Yip and Ng in conjunction with a cyclic prefix and a basic sequence having ideal autocorrelation.

One step ahead is that of using a basic sequence having ideal periodic autocorrelation and constant amplitude:

|sᵢ|²=1/N (10)

In the literature, a sequence having ideal periodic autocorrelation and constant amplitude is called CAZAC (Constant Amplitude Zero AutoCorrelation). An example of CAZAC sequence is given in U.S. Pat. No. 3,008,125. A family of CAZAC sequences with N=2²ⁿ was proposed by R. L. Frank e S. A. Zadoff, “Phase shift pulse codes with good periodic correlation properties”, IRE Transactions on Information Theory, pp. 381-382, October 1962. Later, Chou “Polyphase codes with good periodic correlation properties”, IEEE Transactions on Information Theory, July 1972, pp. 531, found CAZAC sequences with N not equal to 2²ⁿ.

An attractive family of CAZAC sequences is that with N=2ⁿ. In this way, the cyclic convolution expressed in (1) and (3) can be realized in the discrete frequency domain,

making use of the FFT/IFFT algorithm according to the known art.

Observe that, from the independence assumption made on the user's sequences, when a CAZAC sequence is taken as basic sequence, the second-order moments of x are stationary and its discrete power spectrum is white. In other words, we have an ideal distribution of the multiplexed signal both in time and frequency.

The advantage of the proposed construction is that MultiUser Interference (MUI) becomes InterSymbol Interference (ISI), and it is known that reception of a signal affected by ISI and noise is much simpler that reception of a signal affected by MUI and noise.

Basically, all the techniques developed in the past for the ISI channel can be used here. Specifically, optimal reception is obtained by the popular algorithm by A. J. Viterbi “Error bounds for convolutional codes and an asymptotically optimum decoding algorithm”, IEEE Transactions on Information Theory, April 1967, pp. 260-269, with its several variants, as, for instance, L. R. Bahl et al. “Optimal decoding of linear codes for minimizing symbol error rate”, IEEE Transactions on Information Theory, March 1974, pp. 284-287.

The complexity of the Viterbi algorithm is |A|^{v}, where v is the duration of the impulse response of the channel.

Note that we have ISI generated from cyclic convolution. Therefore, the reception techniques to be adopted are those that allow treating cyclical ISI. Specifically, it is present in the literature a version of the Viterbi algorithm known as Tailbiting that applies to the said cyclical case, see for instance the paper by J. B. Anderson e S. M. Hladik “Tailbiting MAP decoders”, IEEE Journal on selected Areas in Communications, February 1998, pag. 297-302. According to the tailbiting technique, detection is based on a trellis, as in the Viterbi algorithm. It is specific to tailbiting that the trellis associated to the transmitted symbol vector is periodic, while in the non-tailbiting case we have a non-periodic trellis associated to the entire sequence of transmitted symbols, independently of the length of the transmitted sequence.

Suboptimal reception is also possible, drawing from the broad class of suboptimal receivers proposed in the past for the ISI channel, and using the tailbiting technique.

Our simulation shows that, using the well known technique for shortening the impulse response of the channel by a filter placed before the Viterbi algorithm, 4≦v≦6 leads to virtually optimal reception for UMTS test channels, while 16≦N≦256. Therefore our scheme practically achieves optimal detection of CDMA. From the simulations, we have a gain of 3 dB or more at BER=10⁻³ over the most advanced receivers today proposed for UMTS.

The use of CAZAC sequences in transmission based on code division multiplexing dramatically reduces the complexity of the receiver when the channel placed between the transmitted and the receiver is affected by multipath.

Multipath occurs in most of radio communication systems (excepting satellite systems).

The use of these sequences in transmission based on code division makes signal processing at the receiver easier compared to other sequences, for instance Hadamard sequences today used in UMTS in the link from the base station to the users.

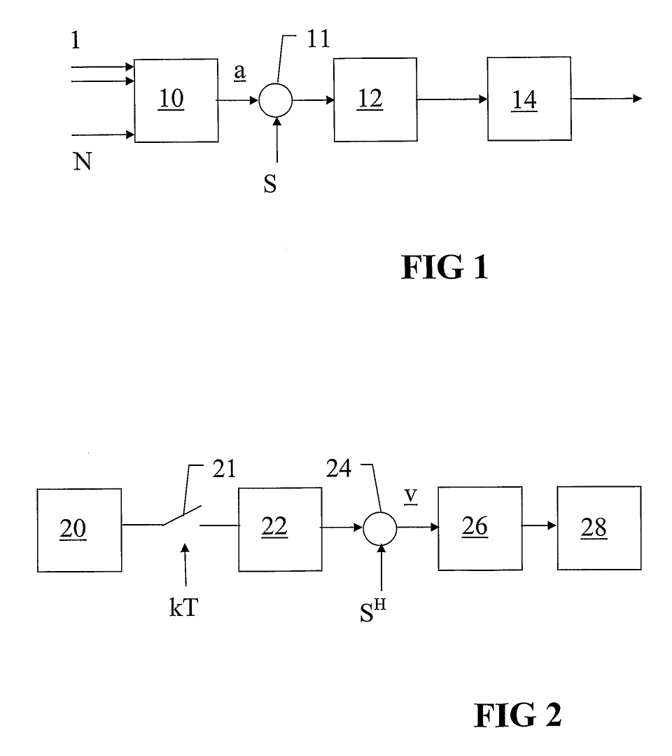

With reference to FIG. 1, the signals coming from N users are applied to block 10 whose output is vector a, which is applied to a multiplier 11 which computes the product between the vector and matrix S. Being S a cyclic convolution matrix, said product is the cyclic convolution between vector a and the basic sequence s. Therefore said product can be realized used the known techniques for realization of cyclic convolution, among which those based on the FFT/IFFT algorithm.

The cyclic prefix is added to vector x in block 12, the signal is then filtered by the transmit filter 14 and after the signal is transmitted.

With reference to FIG. 2, the received signal is filtered by the receive filter 20, then it is sampled by the sampling device 21, with sampling interval T, where T is the duration of the samples of the multiplexed vector plus cyclic prefix.

The cyclic prefix is removed by block 22 (using a suitable synchronism obtained by known technique, the synchronism indicating the begin and the end of the part to be removed), then the signal is multiplied by matrix S^{H}, that is the conjugate transposed of matrix S, then it is fed to a receiver 26, receiver that uses Viterbi method or Bahl method in Tailbiting form, or suboptimal methods derived from the mentioned methods, then the signal enters block 28, that represents further processing of the signal.

The present invention makes use of a basic sequence with ideal periodic autocorrelation, but the system could work even with substantially ideal cyclic autocorrelation, that is

S^{H}S=I+Q

where Q is a matrix whose entries are small compared to 1.

The present invention makes use of a basic sequence with constant amplitude, but the system could work even with substantially constant amplitude, that is

|sₗ|²=(1/N)+εₗ

where εᵢ is small compared to 1/N.

The present invention refers to systems based on synchronous CDMA. Therefore, when we consider a basic sequence with substantially ideal periodic autocorrelation, we do not consider the sequence made as one 1 followed by N−1 zeros, because in this case we have a system based on time division.

1. Transmission method based on code division (CDMA) including the steps of
multiplying signal (a) to be transmitted, represented by a vector, by matrix (S), the result being a vector (x),
said method being characterized in that
taking a basic sequence having substantially ideal periodic autocorrelation;
constructing said matrix (S) by a cyclical translation of said basic sequence, in such a way that the columns of said matrix (S) are the cyclical translations of the basic sequence;
adding a cyclical prefix to said resulting vector (x).

2. The transmission method of claim 1, characterized in that said basic sequence is a sequence with substantially ideal periodic autocorrelation and substantially constant amplitude.

3. The transmission method of claim 1, characterized in that said matrix (S) has columns that are substantially orthogonal.

4. The transmission method of claim 1, characterized in that the step of adding a cyclical prefix to said resulting vector (x) includes the step of considering the final portion of said vector (x), portion of length M≦N, and adding it at the beginning of said vector (x).

5. Reception method adapted to receive a signal based on code division (CDMA) according to claim 1, characterized in that includes the step of removing said cyclical prefix, the step of multiplying the received signal by the transposed conjugate of said matrix (S), and the step of reception that makes use of one among the receivers that are commonly adopted for the channel with cyclical ISI.

6. The reception method of claim 5, characterized by including the receiving step using the tailbiting Viterbi's method.

7. The reception method of claim 5 characterized by including the receiving step using the tailbiting Bhal's method.

8. Transmission system based on code division (CDMA) including means to multiply signal (a) to be transmitted, represented by a vector, by a matrix (S), whose result is represented by a resulting vector (x);
characterized in that it further includes means for taking a basic sequence having substantially ideal periodic autocorrelation;
means for constructing said matrix (S) by a cyclical translation of said basic sequence, in such a way that the columns of said matrix are the cyclical translations of the basic sequence,
means for adding a cyclic prefix to said resulting vector (x);

9. Reception system adapted to receive a code division transmission (CDMA) according to claim 8, characterized in that includes means for removing the cyclical prefix; a receiver using the tailbiting Viterbi's method or the tailbiting Bhal's method.
